(19) United States
(12) Patent Application Publication
(10) Pub. No.: US 2025/0254708 A1
(43) Pub. Date: Aug. 7, 2025

(54) METHOD AND DEVICE FOR TRANSMISSION SYNCHRONIZATION, AND STORAGE MEDIUM

(71) Applicant: Beijing Xiaomi Mobile Software Co., Ltd., Beijing (CN)

(72) Inventors: Xiaofei LIU, Beijing (CN); Yumin WU, Beijing (CN)

(73) Assignee: Beijing Xiaomi Mobile Software Co., Ltd., Beijing (CN)

(21) Appl. No.: 18/856,242

(22) PCT Filed: Apr. 12, 2022
(86) PCT No.: PCT/CN2022/086431

§ 371 Date: Oct. 11, 2024

(51) Int. Cl. H04W 72/30; H04W 56/00; H04W 72/23

(52) U.S. Cl. CPC H04W 72/30; H04W 56/0015; H04W 72/23

(57) ABSTRACT

A method and apparatus, and a storage medium for transmission synchronization in a wireless communication system. The transmission synchronization is performed by: sending synchronization control information to at least one first network-side node, wherein the synchronization control information is configured to control the at least one first network-side node to perform multicast broadcast service (MBS) control channel (MCCH) transmission synchronization.

### CROSS-REFERENCE TO RELATED APPLICATIONS

The present application is a U.S. National Stage of International Application No. PCT/CN2022/086431, filed on Apr. 12, 2022, the contents of all of which are incorporated herein by reference in their entirety for all purposes.

### BACKGROUND OF THE INVENTION

Currently, Release 17 (R17) only supports multicast broadcast service (MBS) synchronization in the intra-distributed unit (intra-DU) scenario, i.e., MBS synchronization in a single-frequency network.

### SUMMARY OF THE INVENTION

The present disclosure relates to the field of communications, in particular to a method and device for transmission synchronization, and a storage medium.

According to a first aspect of embodiments of the present disclosure, a method for transmission synchronization is provided. The method is performed by a second network-side node and includes:
sending synchronization control information to at least one first network-side node, where the synchronization control information is configured to control the at least one first network-side node to perform multicast broadcast service (MBS) control channel (MCCH) transmission synchronization.

According to a second aspect of embodiments of the present disclosure, a method for transmission synchronization is provided. The method is performed by a first network-side node and includes:
receiving synchronization control information sent by a second network-side node, where the synchronization control information is configured to control the at least one first network-side node to perform multicast broadcast service (MBS) control channel (MCCH) transmission synchronization; and
performing the MCCH transmission synchronization based on the synchronization control information.

According to a third aspect of embodiments of the present disclosure, a device for transmission synchronization is provided, which includes:
a processor; and
a memory that stores processor-executable instructions, where the processor is configured to execute the processor-executable instructions to cause the device to send synchronization control information to at least one first network-side node, where the synchronization control information is configured to control the at least one first network-side node to perform multicast broadcast service (MBS) control channel (MCCH) transmission synchronization.

According to a fourth aspect of embodiments of the present disclosure, a device for transmission synchronization is provided, which includes:
a processor; and
a memory that stores processor-executable instructions, where the processor is configured to execute the processor-executable instructions to cause the device to perform the method according to any one of the second aspect.

It should be understood that the above general description and the following detailed description are only exemplary and illustrative, which are not intended to limit the present disclosure.

### BRIEF DESCRIPTION OF DRAWINGS

The drawings herein are incorporated into the specification and constitute a part of the specification, which illustrate embodiments that are consistent with the present disclosure and are used together with the specification to explain the principles of the present disclosure.

FIG. 1 is a schematic flowchart of a method for transmission synchronization according to an example.

FIG. 2 is a schematic flowchart of a method for transmission synchronization according to another example.

FIG. 3 is a schematic flowchart of a method for transmission synchronization according to another example.

FIG. 4 is a schematic flowchart of a method for transmission synchronization according to another example.

FIG. 5 is a block diagram of a device for transmission synchronization according to an example.

FIG. 6 is a block diagram of a device for transmission synchronization according to an example.

FIG. 7 is a schematic structural diagram of a device for transmission synchronization according to an example of the present disclosure.

FIG. 8 is a schematic structural diagram of a device for transmission synchronization according to another example of the present disclosure.

### DETAILED DESCRIPTION OF THE INVENTION

The example embodiments will be described in detail herein, and examples thereof are shown in the accompanying drawings. When the following description relates to the accompanying drawings, the same numbers in different accompanying drawings refer to the same or similar elements unless otherwise indicated. The embodiments described in the following examples do not represent all embodiments consistent with the embodiments of the present disclosure. Rather, they are merely instances of devices and methods consistent with some aspects of the appended claims of the present disclosure.

Terms used in the embodiments of the present disclosure is for the purpose of describing particular embodiments merely and are not intended to limit the embodiments of the present disclosure. As used in the embodiments of the present disclosure, singular forms “a,” “an” and “the/said” are intended to include plural forms as well, unless otherwise indicated in the context clearly. It should be understood that the term “and/or” as used here refers to and encompasses any or all possible combinations of at least one of the associated listed items.

It should be understood that although the terms of “first,” “second,” “third” and the like may be used in the embodiments of the present disclosure to describe various information, such information should not be limited to these terms. These terms are merely used to distinguish the same type of information from each other. For example, first information may also be referred to as second information, and similarly, second information may also be referred to as first information, without departing from the scope of the embodiments of the present disclosure. The word “if” as used here may be construed to mean “at the time of,” or “when,” or “in response to determining,” depending on the context.

In the 5^{th} Generation Mobile Communication Technology (5G) New Radio (NR) system, a multicast broadcast service (MBS) service may be marked with an MBS service identity. The MBS service identity includes at least one of the followings: a temporary mobile group identity (TMGI), an MBS Session ID and an MBS QoS flow ID.

There are two sending modes for the MBS service below.

In the sending mode 1 (multicast sending), a terminal enters a radio resource control-connected state (RRC_CONNECTED) to receive sending configuration information of the MBS service, and then receive the MBS service. A network-side node sends receiving configuration information of the MBS service to the terminal through terminal-specific signaling.

In the sending mode 2 (broadcast sending), the terminal may receive the sending configuration information of the MBS service in an IDLE state, an INACTIVE state, or a CONNECTED state, and receive the MBS service. The network-side node sends the receiving configuration information of the MBS service to the terminal through system information and MBS control channel (MCCH) information. The system information may be a system information block (SIB).

Currently, Release 17 (R17) only supports MBS synchronization in the intra-distributed unit (intra-DU) scenario, i.e., MBS synchronization in a single-frequency network.

However, only supporting the single-frequency network in the intra-DU scenario limits the number of deployed single-frequency network cells, thereby restricting the expected gain of the single-frequency network.

Given that the MBS service is specific to a single-frequency network, the number of deployed single-frequency network cells and the expected gain of the single-frequency network are limited. In order to solve the above technical problems, a method and device for transmission synchronization, and a storage medium are provided in the present disclosure below.

The following introduces a method for transmission synchronization provided by the present disclosure from a second network-side node.

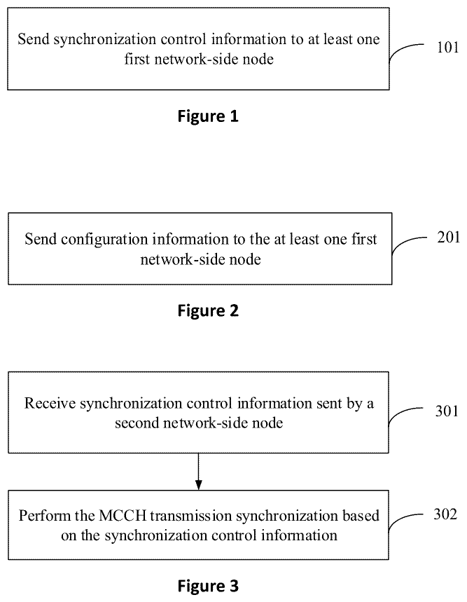

A method for transmission synchronization is provided according to an embodiment of the present disclosure. As shown in FIG. 1, FIG. 1 is a flowchart of a method for transmission synchronization according to an embodiment, which may be performed by a second network-side node. The second network-side node may be a base station, a centralized unit (CU), a distributed unit (DU), or a network-side node (e.g., an MBS master node) independent of the above-mentioned nodes, which is not limited in the present disclosure. The method may include steps as follows.

In step 101, synchronization control information is sent to at least one first network-side node.

In the embodiment of the present disclosure, the synchronization control information is configured to control the at least one first network side node to perform MCCH transmission synchronization.

In the embodiment of the present disclosure, the method may be performed by an NR or a communication system that follows the NR.

In the above embodiment, the second network-side node can control at least one first network-side node to enable MCCH transmission synchronization, enable MBS synchronization in the NR system, support wide-area service deployment, expand the single-frequency network transmission scenarios, and improve cell edge performance and spectrum utilization, resulting in high availability.

In some optional embodiments, the MCCH transmission synchronization includes at least one of the followings: MCCH transmission content synchronization; physical downlink control channel (PDCCH) transmission synchronization corresponding to the MCCH transmission; physical downlink shared channel (PDSCH) transmission synchronization corresponding to the MCCH transmission; MCCH transmission configuration information synchronization; or MCCH modification notification information synchronization.

The MCCH transmission content synchronization refers to the synchronization of control information transmitted in an MCCH channel. The MCCH transmission content includes MBS configuration information and specifically may include at least one of an MBS broadcast session or scheduling information for the MBS broadcast session.

The PDCCH transmission synchronization corresponding to the MCCH transmission may be performed through inter-node signaling, where the inter-node signaling may be the inter-node signaling. The PDCCH transmission synchronization includes at least one of downlink control Information (DCI) transmission content synchronization or DCI transmission resource synchronization.

The PDSCH transmission synchronization corresponding to the MCCH transmission may be performed through DCI transmission content synchronization.

The MCCH transmission configuration information may be carried in an SIB to configure and receive MCCH. Specifically, the MCCH transmission configuration information includes at least one of a sending period of information in the MCCH, a sending resource position of the information in the MCCH. The sending resource position includes, but is not limited to, a sending time-frequency resource position.

The second network-side device sends MCCH modification notification information to at least one first network-side node in response to determining at least one of the followings: that the MCCH transmission content changes, that an MBS session is about to begin, or that the MBS session ends.

FIG. 2 is a flowchart of a method for transmission synchronization according to an embodiment, which may be performed by a second network-side node. In some optional embodiments, as shown in FIG. 2, the second network-side node may be a base station, a CU, a DU, or a network-side node (e.g., an MBS master node) independent of the above-mentioned nodes. The method may include steps as follows.

In step 201, configuration information is sent to the at least one first network-side node.

In the embodiment of the present disclosure, the configuration information is configured to configure an effect duration for the MCCH transmission content synchronization and/or the MCCH transmission configuration information synchronization. The effect duration refers to the duration during which the control information remains valid after the terminal synchronizes the control information of the MCCH transmission. After synchronizing the MCCH, the terminal can perform MCCH synchronization again once the effect duration has elapsed. In one implementation, the configuration information includes a periodic duration, with the effect duration being at least one slot within the period. At least one slot within the period may be part or all of the slots included in that period, which is limited in the present disclosure.

In another implementation, the configuration information may include a reference time period. The effect duration may be at least one slot included in the reference time period. At least one slot included in the reference time period may be some or all of the slots included in the reference time period, which is not limited in the present disclosure. The reference time period includes, but is not limited to, an absolute time period, a system frame number (SFN) index, a subframe index, and a slot index.

Optionally, in a case where the reference time period is the absolute time period, the first network-side node may determine that the effect duration is at least one slot included in the absolute time period. At least one slot included in the absolute time period may be some or all of the slots included in the absolute time period, which is not limited in the present disclosure.

Optionally, in a case where the reference time period is the SFN index, the first network-side node may determine that the effect duration is at least one slot included in at least one system frame corresponding to the system frame index. At least one system frame corresponding to the system frame index may be some or all of the system frames corresponding to the system frame index, and at least one slot included in at least one system frame corresponding to the system frame index may be some or all of the slots included in at least one system frame corresponding to the system frame index, which is not limited in the present disclosure.

Optionally, in a case where the reference time period is the subframe index, the first network-side node may determine that the effect duration is at least one slot included in at least one subframe corresponding to the subframe index. At least one subframe corresponding to the subframe index may be some or all of the subframes corresponding to the subframe index, and at least one slot included in at least one subframe corresponding to the subframe index may be some or all of the slots included in at least one subframe corresponding to the subframe index, which is not limited in the present disclosure.

Optionally, in a case where the reference time period is the slot index, the first network-side node may determine that the effect duration is at least one slot corresponding to the slot index. At least one slot corresponding to the slot index may be some or all of the slots corresponding to the slot index, which is not limited in the present disclosure.

In another implementation, the configuration information may include a reference time point. The effect duration may be at least one slot before or after the reference time point. At least one slot before or after the reference time point may be some or all of the slots before or after the reference time point, which is not limited in the present disclosure.

The reference time point includes, but is not limited to, an absolute time point, an SFN index, a subframe index, and a slot index.

Optionally, in a case where the reference time point is the absolute time point, the first network-side node may determine that the effect duration is at least one slot before or after the absolute time point. At least one slot before or after the absolute time point may be some or all of the slots before or after the absolute time point, which is not limited in the present disclosure.

Optionally, in a case where the reference time point is the SFN index, the first network-side node may determine that the effect duration is at least one slot before or after at least one system frame corresponding to the system frame index. At least one system frame corresponding to the system frame index may be some or all of the system frames corresponding to the system frame index, and at least one slot before or after at least one system frame corresponding to the system frame index may be some or all of the slots before or after at least one system frame corresponding to the system frame index, which is not limited in the present disclosure.

Optionally, in a case where the reference time point is the subframe index, the first network-side node may determine that the effect duration is at least one slot before or after at least one subframe corresponding to the subframe index. At least one subframe corresponding to the subframe index may be some or all of the subframes corresponding to the subframe index, and at least one slot before or after at least one subframe corresponding to the subframe index may be some or all of the slots before or after at least one subframe corresponding to the subframe index, which is not limited in the present disclosure.

Optionally, in a case where the reference time point is the slot index, the first network-side node may determine that the effect duration is at least one slot before or after at least one slot corresponding to the slot index. At least one slot corresponding to the slot index may be some or all of the slots corresponding to the slot index, and at least one slot before or after at least one slot corresponding to the slot index may be some or all of the slots before or after at least one slot corresponding to the slot index, which is not limited in the present disclosure.

In some optional embodiments, the MCCH modification notification information synchronization includes at least one of PDCCH transmission synchronization corresponding to the MCCH modification notification information or radio network temporary identifier (RNTI) synchronization, where an RNTI is associated with a PDCCH corresponding to the MCCH modification notification information.

In some optional embodiments, the MCCH transmission configuration information includes at least one of an MCCH transmission repetition period, an MCCH transmission window length, or an MCCH modification period.

The MCCH transmission repetition period may be determined from configured radio frame length and mcch-RepetitionPeriodAndOffset (i.e., an offset).

The MCCH transmission window length may be determined from configured mcch-WindowStartSlot (i.e., starting slot) and mcch-WindowDuration (i.e., duration).

For the MCCH modification period, the MCCH transmission content may be different only at the boundary of the MCCH modification period. The boundary of the MCCH modification period may be determined from configured mcch-ModificationPeriod (MCCH modification period). In other words, the boundary of the MCCH modification period may be a radio frame where the SFN index mod mcch-ModificationPeriod=0.

In the above embodiment, the second network-side node may configure a time period for performing the MCCH transmission content synchronization and/or the MCCH transmission configuration information synchronization for the first network-side node, so that the at least one first network-side node can be controlled to perform MCCH transmission synchronization, thereby saving the signaling resources and reducing delay.

In some optional embodiments, the second network-side node may send the synchronization control information to the at least one first network-side node through inter-node signaling, where the synchronization control information is configured to control the at least one first network-side node to perform the MCCH transmission content synchronization and/or the PDCCH transmission synchronization. Specifically, the inter-node signaling may be the inter-node signaling as described above.

In the above embodiment, the MCCH transmission synchronization can be enabled through inter-node signaling, thereby enhancing simplicity and availability.

According to the present disclosure, a method for transmission synchronization at a first network-side node is provided below.

According to the embodiment of the present disclosure, a method for transmission synchronization is provided. As shown in FIG. 3, FIG. 3 is a flowchart of a method for transmission synchronization according to an embodiment, which may be performed by a first network-side node. The first network-side node may be a CU or a DU. The method may include the following steps.

In step 301, synchronization control information sent by a second network-side node is received.

In the embodiment of the present disclosure, the synchronization control information is configured to control the at least one first network-side node to perform MCCH transmission synchronization.

In step 302, the MCCH transmission synchronization is performed based on the synchronization control information.

In the embodiment of the present disclosure, the method may be performed by an NR or a communication system that follows the NR.

In the above embodiment, the first network-side node can synchronize the MCCH transmission based on the synchronization control information sent by the second network-side node. This enables MBS synchronization in an NR system, supports wide-area service deployment, expands the single-frequency network transmission scenario, improves cell edge performance and spectrum utilization, and enhances availability.

In some optional embodiments, the MCCH transmission synchronization includes at least one of MCCH transmission content synchronization, PDCCH transmission synchronization corresponding to the MCCH transmission, PDSCH transmission synchronization corresponding to the MCCH transmission, MCCH transmission configuration information synchronization, or MCCH modification notification information synchronization.

The MCCH transmission content synchronization refers to the synchronization of control information transmitted in an MCCH channel. The MCCH transmission content includes MBS configuration information and specifically may include at least one of an MBS broadcast session or scheduling information for the MBS broadcast session.

The PDCCH transmission synchronization corresponding to the MCCH transmission may be enabled through inter-node signaling, where the inter-node signaling may be the inter-node signaling as described above. The PDCCH transmission synchronization includes at least one of DCI transmission content synchronization or DCI transmission resource synchronization.

The PDSCH transmission synchronization corresponding to the MCCH transmission may be enabled through DCI transmission content synchronization.

The MCCH transmission configuration information may be carried in an SIB to configure the reception of the MCCH. Specifically, the MCCH transmission configuration information includes at least one of the followings: a sending period of information in MCCH; or a sending resource position of the information in MCCH. The resource position includes, but is not limited to, a time-frequency resource position.

The second network-side device sends MCCH modification notification information to at least one first network-side node in response to determining at least one of the followings: that the MCCH transmission content changes, that an MBS session is about to begin, or that the MBS session ends.

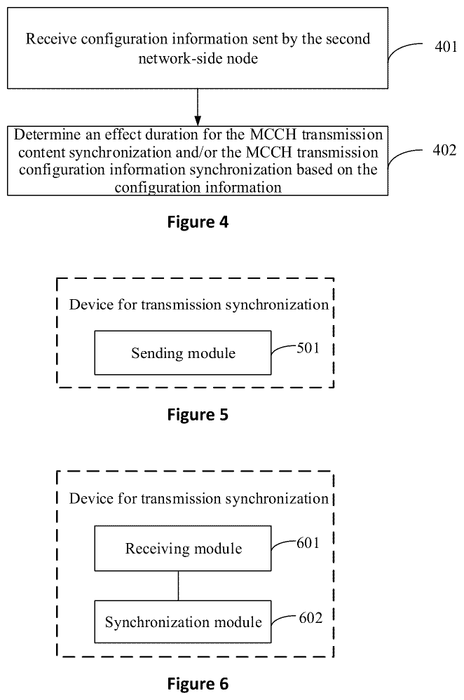

FIG. 4 is a flowchart of a method for transmission synchronization according to an embodiment, which may be performed by a first network-side node. In some optional embodiments, as shown in FIG. 4, the first network-side node may be a CU or a DU. The method may include steps as follows.

In step 401, configuration information sent by the second network-side node is received.

In the embodiment of the present disclosure, the configuration information is configured to configure an effect duration for the MCCH transmission content synchronization and/or the MCCH transmission configuration information synchronization. The effect duration refers to the duration during which the control information remains valid after the terminal synchronizes the control information of the MCCH transmission. After synchronizing the MCCH, the terminal can perform MCCH synchronization again once the effect duration has elapsed. In step 402, the effect duration for the MCCH transmission content synchronization and/or the MCCH transmission configuration information synchronization is determined based on the configuration information.

In one implementation, the configuration information includes a periodic duration, with the effect duration being at least one slot within the period. At least one slot within the period may be part or all of the slots included in that period, which is limited in the present disclosure.

In another implementation, the configuration information may include a reference time period. The effect duration may be at least one slot included in the reference time period. At least one slot included in the reference time period may be some or all of the slots included in the reference time period, which is not limited in the present disclosure.

The reference time period includes, but is not limited to, an absolute time period, an SFN index, a subframe index, and a slot index.

Optionally, in a case where the reference time period is the absolute time period, the first network-side node may determine that the effect duration is at least one slot included in the absolute time period. At least one slot included in the absolute time period may be some or all of the slots included in the absolute time period, which is not limited in the present disclosure.

Optionally, in a case where the reference time period is the SFN index, the first network-side node may determine that the effect duration is at least one slot included in at least one system frame corresponding to the system frame index. At least one system frame corresponding to the system frame index may be some or all of the system frames corresponding to the system frame index, and at least one slot included in at least one system frame corresponding to the system frame index may be some or all of the slots included in at least one system frame corresponding to the system frame index, which is not limited in the present disclosure.

Optionally, in a case where the reference time period is the subframe index, the first network-side node may determine that the effect duration is at least one slot included in at least one subframe corresponding to the subframe index. At least one subframe corresponding to the subframe index may be some or all of the subframes corresponding to the subframe index, and at least one slot included in at least one subframe corresponding to the subframe index may be some or all of the slots included in at least one subframe corresponding to the subframe index, which is not limited in the present disclosure.

Optionally, in a case where the reference time period is the slot index, the first network-side node may determine that the effect duration is at least one slot corresponding to the slot index. At least one slot corresponding to the slot index may be some or all of the slots corresponding to the slot index, which is not limited in the present disclosure. In another possible implementation, the configuration information may include a reference time point. The effect duration may be at least one slot before or after the reference time point. At least one slot before or after the reference time point may be some or all of the slots before or after the reference time point, which is not limited in the present disclosure.

The reference time point includes, but is not limited to, an absolute time point, an SFN index, a subframe index, and a slot index.

Optionally, in a case where the reference time point is the absolute time point, the first network-side node may determine that the effect duration is at least one slot before or after the absolute time point. At least one slot before or after the absolute time point may be some or all of the slots before or after the absolute time point, which is not limited in the present disclosure.

Optionally, in the case where the reference time point is the SFN index, the first network-side node may determine that the effect duration is at least one slot before or after at least one system frame corresponding to the system frame index. At least one system frame corresponding to the system frame index may be some or all of the system frames corresponding to the system frame index, and at least one slot before or after at least one system frame corresponding to the system frame index may be some or all of the slots before or after at least one system frame corresponding to the system frame index, which is not limited in the present disclosure.

Optionally, in a case where the reference time point is the subframe index, the first network-side node may determine that the effect duration is at least one slot before or after at least one subframe corresponding to the subframe index. At least one subframe corresponding to the subframe index may be some or all of the subframes corresponding to the subframe index, and at least one slot before or after at least one subframe corresponding to the subframe index may be some or all of the slots before or after at least one subframe corresponding to the subframe index, which is not limited in the present disclosure.

Optionally, in a case where the reference time point is the slot index, the first network-side node may determine that the effect duration is at least one slot before or after at least one slot corresponding to the slot index. At least one slot corresponding to the slot index may be some or all of the slots corresponding to the slot index, and at least one slot before or after at least one slot corresponding to the slot index may be some or all of the slots before or after at least one slot corresponding to the slot index, which is not limited in the present disclosure.

In some optional embodiments, the MCCH modification notification information synchronization includes at least one of PDCCH transmission synchronization corresponding to the MCCH modification notification information or RNTI synchronization, where an RNTI is associated with a PDCCH corresponding to the MCCH modification notification information.

In some optional embodiments, the MCCH transmission configuration information includes at least one of an MCCH transmission repetition period, an MCCH transmission window length, or an MCCH modification period.

The MCCH transmission repetition period may be determined from configured radio frame length and mcch-RepetitionPeriodAndOffse (i.e., an offset).

The MCCH transmission window length may be determined from configured mcch-WindowStartSlot (i.e., starting slot) and mcch-WindowDuration (i.e., duration).

For the MCCH modification period, the MCCH transmission content may only differ at the boundary of the MCCH modification period. The boundary of the MCCH modification period may be determined from configured mcch-ModificationPeriod (i.e., MCCH modification period). In other words, the boundary of the MCCH modification period may be a radio frame where the SFN index mod mcch-ModificationPeriod=0.

In some optional embodiments, the first network-side node may receive synchronization control information sent by the second network-side node through inter-node signaling, where the synchronization control information is configured to control the at least one first network-side node to perform the MCCH transmission content synchronization and/or the PDCCH transmission synchronization. Specifically, the inter-node signaling may be the inter-node signaling as described above.

In the above embodiment, the MCCH transmission synchronization can be enabled through inter-node signaling, thereby enhancing simplicity and availability.

Corresponding to the foregoing application functions implementing the method embodiments, application functions implementing device embodiments are further provided in the present disclosure.

Referring to FIG. 5, FIG. 5 is a block diagram of a device for transmission synchronization according to an example. The device for transmission synchronization is performed by a second network-side node and includes:
a sending module 501, configured to send synchronization control information to at least one first network-side node, where the synchronization control information is configured to control the at least one first network-side node to perform MCCH transmission synchronization.

Referring to FIG. 6, FIG. 6 is a block diagram of a device for transmission synchronization according to an example. The device for transmission synchronization is performed by a first network-side node and includes:
a receiving module 601, configured to receive synchronization control information sent by a second network-side node, where the synchronization control information is configured to control the at least one first network-side node to perform MCCH transmission synchronization; and
a synchronization module 602, configured to perform the MCCH transmission synchronization based on the synchronization control information.

For the device embodiments, since they basically correspond to the method embodiments, refer to the part of the description of the method embodiments for related parts. The device embodiments described above are merely illustrative, where the units described as separate components may or may not be physically separated. The components displayed as units may or may not be physical units, i.e., may be located in one place, or may also be distributed on a plurality of network units. Some or all of the modules can be selected according to actual needs to achieve the object of the solution of the present disclosure. Those of ordinary skill in the art can understand and implement the present disclosure without requiring any creative effort.

Correspondingly, a non-transitory computer-readable storage medium storing a computer program is further provided according to the present disclosure, where the computer program is configured to implement any one of the methods for transmission synchronization performed by the second network-side node.

Correspondingly, a non-transitory computer-readable storage medium storing a computer program is further provided according to the present disclosure, where the computer program is configured to implement any one of the methods for transmission synchronization performed by the first network-side node.

Correspondingly, a device for transmission synchronization is further provided according to the present disclosure, which includes:
a processor; and
a memory that stores processor executable instructions, where the processor is configured to perform the steps of any one of the methods for transmission synchronization performed by the second network-side node.

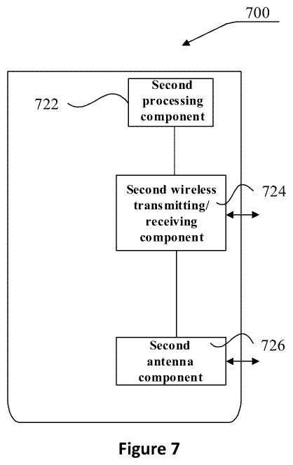

As shown in FIG. 7, FIG. 7 is a schematic structural diagram of a device for transmission synchronization 700 according to an example. The device for transmission synchronization 700 may be provided as a second network-side node. Referring to FIG. 7, the device for transmission synchronization 700 includes a second processing component 722, a second wireless transmitting/receiving component 724, a second antenna component 726, and a signal processing portion specific to a wireless interface. The second processing component 722 may further include at least one processor.

One of the processors in the second processing component 722 may be configured to perform any one of the methods for transmission synchronization performed by the second network-side node.

Correspondingly, a device for transmission synchronization is further provided according to the present disclosure, which includes:
a processor; and
a memory that stores processor executable instructions, where the processor is configured to perform any one of the methods for transmission synchronization performed by the first network-side node.

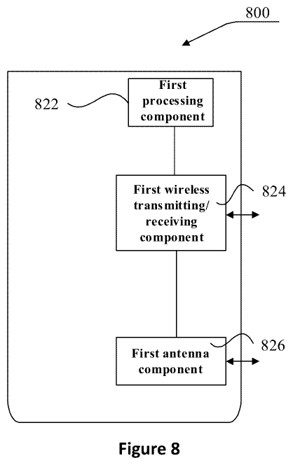

As shown in FIG. 8, FIG. 8 is a schematic structural diagram of a device for transmission synchronization 800 according to an example embodiment. The device for transmission synchronization 800 may be provided as a first network-side node. Referring to FIG. 8, the device for transmission synchronization 800 includes a first processing component 822, a first wireless transmitting/receiving component 824, a first antenna component 826, and a signal processing portion specific to a wireless interface. The first processing component 822 may further include at least one processor.

One of the processors in the first processing component 822 may be configured to perform any one of the methods for transmission synchronization performed by the first network-side node.

The technical solutions provided by the embodiments of the present disclosure may include the following beneficial effects.

In the present disclosure, the second network-side node can control at least one first network-side node to enable MCCH transmission synchronization, enable MBS synchronization in the NR system, support wide-area service deployment, expand the single-frequency network transmission scenarios, and improve cell edge performance and spectrum utilization, resulting in high availability.

Those skilled in the art will readily conceive other embodiments of the present disclosure upon consideration of the specification and practice of the present disclosure above. The present disclosure is intended to cover any variations, uses, or adaptations of the present disclosure. These variations, uses, or adaptations comply with the general principles of the present disclosure, and include common knowledge or customary technical means in the art which are not disclosed herein. The specification and embodiments are to be considered as illustrative merely, and the scope and spirit of the embodiments of the present disclosure are defined by the following claims.

It should be understood that the present disclosure is not limited to the precise structures described above and shown in the accompanying drawings, and various modifications and changes can be made without departing from the scope of the present disclosure. The scope of the present disclosure is defined by the following claims.

1. A method for transmission synchronization performed by a second network-side node, the method comprising:
sending synchronization control information to at least one first network-side node,
wherein the synchronization control information is configured to control the at least one first network-side node to perform multicast broadcast service (MBS) control channel (MCCH) transmission synchronization.

2. The method according to claim 1, wherein the MCCH transmission synchronization comprises at least one of:
MCCH transmission content synchronization;
physical downlink control channel (PDCCH) transmission synchronization corresponding to MCCH transmission;
physical downlink shared channel (PDSCH) transmission synchronization corresponding to the MCCH transmission;
MCCH transmission configuration information synchronization; or
MCCH modification notification information synchronization.

3. The method according to claim 2, wherein
the MCCH transmission content comprises at least one of an MBS broadcast session or scheduling information for the MBS broadcast session; or
the PDCCH transmission synchronization comprises at least one of downlink control information (DCI) transmission content synchronization or DCI transmission resource synchronization; or
the MCCH transmission configuration information comprises at least one of a sending period of information in MCCH or a sending resource position of the information in the MCCH.

4.-5. (canceled)

6. The method according to claim 2, wherein the method further comprises at least one of:
sending MCCH modification notification information to the at least one first network-side node in response to determining that MCCH transmission content changes;
sending the MCCH modification notification information to the at least one first network-side node in response to determining that an MBS session is about to begin; or
sending the MCCH modification notification information to the at least one first network-side node in response to determining that the MBS session ends.

7. The method according to claim 2, further comprising:
sending configuration information to the at least one first network-side node, wherein the configuration information is configured to configure an effect duration for the MCCH transmission content synchronization and/or the MCCH transmission configuration information synchronization.

8. The method according to claim 2, wherein the MCCH modification notification information synchronization comprises at least one of:
PDCCH transmission synchronization corresponding to MCCH modification notification information; or
radio network temporary identity (RNTI) synchronization, wherein an RNTI is associated with a PDCCH corresponding to the MCCH modification notification information.

9. The method according to claim 2, wherein the MCCH transmission configuration information comprises at least one of an MCCH transmission repetition period, an MCCH transmission window length, or an MCCH modification period.

10. The method according to claim 9, wherein the MCCH transmission repetition period comprises at least one of a radio frame length or an offset; and
the MCCH transmission window length comprises at least one of a starting slot or a duration.

11. The method according to claim 2, wherein sending the synchronization control information to the at least one first network-side node comprises:
sending the synchronization control information to the at least one first network-side node through inter-node signaling, wherein the synchronization control information is configured to control the at least one first network-side node to perform the MCCH transmission content synchronization and/or the PDCCH transmission synchronization.

12. A method for transmission synchronization, the method comprising:
receiving synchronization control information sent by a second network-side node,
wherein the synchronization control information is configured to control at least one first network-side node to perform multicast broadcast service (MBS) control channel (MCCH) transmission synchronization; and
performing the MCCH transmission synchronization based on the synchronization control information.

13. The method according to claim 12, wherein the MCCH transmission synchronization comprises at least one of:
MCCH transmission content synchronization;
physical downlink control channel (PDCCH) transmission synchronization corresponding to MCCH transmission;
physical downlink shared channel (PDSCH) transmission synchronization corresponding to the MCCH transmission;
MCCH transmission configuration information synchronization; or
MCCH modification notification information synchronization.

14. The method according to claim 13, wherein
the MCCH transmission content comprises at least one of an MBS broadcast session or scheduling information for the MBS broadcast session; or
the PDCCH transmission synchronization comprises at least one of downlink control information (DCI) transmission content synchronization or DCI transmission resource synchronization; or
the MCCH transmission configuration information comprises at least one of a sending period of information in MCCH or a sending resource position of the information in the MCCH.

15.-16. (canceled)

17. The method according to claim 13, wherein the method further comprises at least one of:
receiving MCCH modification notification information sent by the second network-side node in response to determining that the MCCH transmission content changes;
receiving the MCCH modification notification information sent by the second network-side node in response to determining that an MBS session is about to begin; or
receiving the MCCH modification notification information sent by the second network-side node in response to determining that the MBS session ends.

18. The method according to claim 13, further comprising:
receiving configuration information sent by the second network-side node,
wherein the configuration information is configured to configure an effect duration for the MCCH transmission content synchronization and/or the MCCH transmission configuration information synchronization; and
determining the effect duration of the MCCH transmission content synchronization and/or the MCCH transmission configuration information synchronization based on the configuration information.

19. The method according to claim 13, wherein the MCCH modification notification information synchronization comprises at least one of:
PDCCH transmission synchronization corresponding to MCCH modification notification information; or
radio network temporary identity (RNTI) synchronization, wherein an RNTI is associated with a PDCCH corresponding to the MCCH modification notification information.

20. The method according to claim 13, wherein the MCCH transmission configuration information comprises at least one of an MCCH transmission repetition period, an MCCH transmission window length, or an MCCH modification period.

21. The method according to claim 20, wherein the MCCH transmission repetition period comprises at least one of a radio frame length or an offset; and
the MCCH transmission window length comprises at least one of a starting slot or a duration.

22. The method according to claim 13, wherein receiving the synchronization control information sent by the second network-side node comprises:
receiving the synchronization control information sent by the second network-side node through inter-node signaling, wherein the synchronization control information is configured to control the at least one first network-side node to perform the MCCH transmission content synchronization and/or the PDCCH transmission synchronization.

23.-26. (canceled)

27. A device for transmission synchronization, the device comprising:
a processor; and
a memory that stores processor-executable instructions, wherein
the processor is configured to execute the processor-executable instructions to cause the device to:
send synchronization control information to at least one first network-side node, wherein the synchronization control information is configured to control the at least one first network-side node to perform multicast broadcast service (MBS) control channel (MCCH) transmission synchronization.

28. A device for transmission synchronization, comprising:
a processor; and
a memory that stores processor-executable instructions, wherein
the processor is configured to execute the processor-executable instructions to cause the device to perform the method according to claim 12.
